(19) United States
(12) Patent Application Publication
(10) Pub. No.: US 2006/0015519 A1
(43) Pub. Date: Jan. 19, 2006

(54) Project manager evaluation

(76) Inventor: Michelle LaBrosse, Stateline, NV (US)

Correspondence Address: Hoffman, Warnick & D'Alessandro LLC, 14th Floor, 75 State Street, Albany, NY, 12207, US

(21) Appl. No.: 11/181,088

(22) Filed: Jul. 14, 2005

Related U.S. Application Data
(60) Provisional application No. 60/587,946, filed on Jul. 14, 2004.

(51) Int. Cl. G06F 17/00

(52) U.S. Cl. 707/101

(57) ABSTRACT

An improved solution for evaluating a project manager is provided. A survey is set up and is provided to participants in a project that is managed by the project manager. The survey asks the participants to rank the importance of various topics and/or aspects of the project, and includes additional questions on each aspect. The content of the survey can be adjusted based on a role of the particular participant in the project. The completed surveys are compiled into a score for the project manager. Further, a report can be generated that includes the score and data on which the score is based.

### CROSS-REFERENCE TO RELATED APPLICATION

The current application claims the benefit of co-pending U.S. Provisional Application No. 60/587,946, filed on Jul. 14, 2004, and entitled “System and Method for Evaluating a Project Manager”, which is hereby incorporated herein by reference.

### BACKGROUND OF THE INVENTION

1. Technical Field

The invention relates generally to evaluating a project manager, and more particularly, to a solution for evaluating a project manager based on feedback from various project participants and their corresponding roles in the project.

2. Background Art

Project management is an important aspect of any business. To this extent, it is important to the success of a business that the project management be performed effectively. As a result, it is desirable to evaluate the management of a project both during and after completion of the project. Further, when a business seeks to hire a new project manager, it is desirable to have a satisfactory solution for evaluating the skills of prospective project managers in an objective manner. Likewise, it would be beneficial for a prospective project manager to have an available reference to illustrate his/her competence apart from a current/former employer. Still further, for some businesses and/or government agencies, the evaluation of the management of a project can be used as evidence to show compliance with one or more applicable regulatory requirements.

However, to date, there is no satisfactory solution for evaluating the management of a project, and therefore, the performance of the project manager that managed/is managing the project. Some proposed solutions only evaluate the project manager after the project, and can be expensive and/or time consuming for a smaller business to purchase, maintain, and/or support. Further, existing solutions may not provide an accurate and/or complete set of results. As a result, these solutions go unused and businesses continue to lose money due to the ineffective management of projects and an inability to identify and correct deficiencies in project management.

To this extent, a need exists for a solution for evaluating a project manager that overcomes one or more of the limitations of the prior art.

### SUMMARY OF THE INVENTION

The invention provides an improved solution for evaluating a project manager. A survey is set up and is provided to participants in a project that is managed by the project manager. The survey asks the participants to rank the importance of various topics and/or aspects of the project, and includes additional questions on each aspect. The content of the survey can be adjusted based on a role of the particular participant in the project. The completed surveys are compiled into a score for the project manager. Further, a report can be generated that includes the score and data on which the score is based. The survey can be periodically provided to the participants during the project, thereby enabling the project manager to make any necessary adjustments during the project. In one embodiment, the invention comprises a web-based tool that can be used to provide a third-party evaluation of a project manager.

A first aspect of the invention provides a method of evaluating a project manager, the method comprising: obtaining a set of participants in a project managed by the project manager; providing a survey for access by each of the set of participants, wherein the survey is altered based on a role of each participant; obtaining a completed survey from at least one of the set of participants; and compiling the at least one completed survey into a score for the project manager.

A second aspect of the invention provides a system for evaluating a project manager, the system comprising: a project module for obtaining a set of participants in a project managed by the project manager; a survey module for providing a survey for access by each of the set of participants, wherein the survey is altered based on a role of each participant; a feedback module for obtaining a completed survey from at least one of the set of participants; and an evaluation module for compiling the at least one completed survey into a score for the project manager.

A third aspect of the invention provides a computer-readable medium for enabling a computer infrastructure to evaluate a project manager, the computer-readable medium comprising computer program code for: obtaining a set of participants in a project managed by the project manager; providing a survey for access by each of the set of participants, wherein the survey is altered based on a role of each participant; obtaining a completed survey from at least one of the set of participants; compiling the at least one completed survey into a score for the project manager; generating a report based on the at least one completed survey and the score; and providing a web page for the report for display to a user.

A fourth aspect of the invention provides a computer-readable medium that includes computer program code to enable a computer infrastructure to evaluate a project manager, the computer-readable medium comprising computer program code for performing the method steps of the invention.

A fifth aspect of the invention provides a method of generating a system for evaluating a project manager, the method comprising: obtaining a computer infrastructure; and deploying means for performing each of the steps of the invention to the computer infrastructure.

A sixth aspect of the invention provides a business method for evaluating a project manager, the business method comprising managing a computer infrastructure that performs each of the steps of the invention; and receiving payment based on the managing step.

A seventh aspect of the invention provides a business method for evaluating a project manager, the business method comprising: generating a license to evaluate the project manager for a project managed by the project manager; obtaining payment information for the license; obtaining a set of participants in the project; providing a survey for access by each of the set of participants; obtaining a completed survey from at least one of the set of participants; and compiling the at least one completed survey into a score for the project manager.

An eighth aspect of the invention provides a business method for providing a third-party evaluation of a project manager, the business method comprising: managing a set (one or more) of evaluations for the project manager; receiving a request for at least one of the set of evaluations; obtaining payment information based on the request; generating a report based on the requested at least one of the set of evaluations; and providing the report to a party specified in the request.

A ninth aspect of the invention provides a business method for providing a project manager certification program, the business method comprising: defining a set of standards for the project manager; managing a set of evaluations for the project manager; determining if the project manager meets the set of standards based on the set of evaluations; and certifying the project manager when the set of standards are met.

The illustrative aspects of the present invention are designed to solve the problems herein described and other problems not discussed, which are discoverable by a skilled artisan.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows an illustrative environment for evaluating a project manager.

FIG. 2 shows an illustrative screen that summarizes a license purchase and obtains payment information.

FIG. 3 shows an illustrative screen that summarizes the status of license(s) for a customer.

FIG. 4 shows illustrative method steps that can be performed by the environment of FIG. 1 according to one embodiment of the invention.

FIG. 5 shows an illustrative screen that obtains various project details.

FIG. 6 shows an illustrative screen displayed to a participant as part of a survey.

FIG. 7 shows an illustrative survey screen that obtains a ranking of a project manager based on a numeric grading scale.

FIG. 8 shows an illustrative report according to one embodiment of the invention.

FIG. 9 shows illustrative method steps for periodically evaluating a project manager according to one embodiment of the invention.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION

As indicated above, the invention provides an improved solution for evaluating a project manager. A survey is set up and is provided to participants in a project that is managed by the project manager. The survey asks the participants to rank the importance of various topics and/or aspects of the project, and includes additional questions on each aspect. The content of the survey can be adjusted based on a role of the particular participant in the project. The completed surveys are compiled into a score for the project manager. Further, a report can be generated that includes the score and data on which the score is based. The survey can be periodically provided to the participants during the project, thereby enabling the project manager to make any necessary adjustments during the project. In one embodiment, the invention comprises a web-based tool that can be used to provide a third-party evaluation of a project manager.

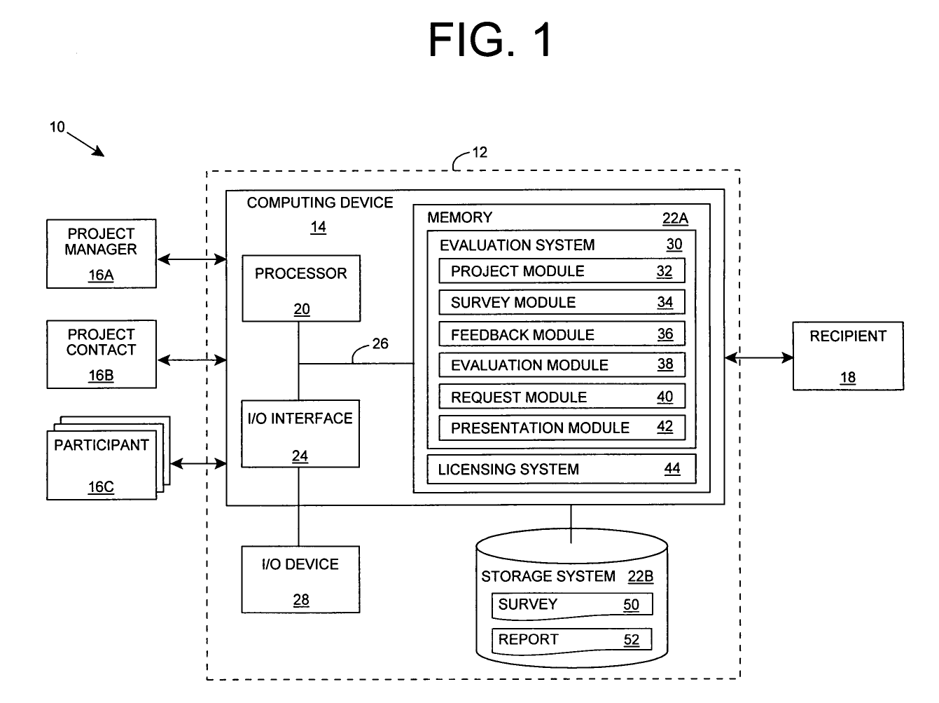

Turning to the drawings, FIG. 1 shows an illustrative environment 10 for evaluating a project manager 16A. To this extent, environment 10 includes a computer infrastructure 12 that can perform the various process steps described herein for evaluating project manager 16A. In particular, computer infrastructure 12 is shown including a computing device 14 that comprises an evaluation system 30, which enables computing device 14 to evaluate project manager 16A by performing the process steps of the invention.

Computing device 14 is shown including a processor 20, a memory 22A, an input/output (I/O) interface 24, and a bus 26. Further, computing device 14 is shown in communication with an external I/O device/resource 28 and a storage system 22B. As is known in the art, in general, processor 20 executes computer program code, such as evaluation system 30, that is stored in memory 22A and/or storage system 22B. While executing computer program code, processor 20 can read and/or write data, such as survey 50, to/from memory 22A, storage system 22B, and/or I/O interface 24. Bus 26 provides a communications link between each of the components in computing device 14. I/O device 28 can comprise any device that enables user 16 to interact with computing device 14 or any device that enables computing device 14 to communicate with one or more other computing devices.

In any event, computing device 14 can comprise any general purpose computing article of manufacture capable of executing computer program code installed by a user 16 (e.g., a personal computer, server, handheld device, etc.). However, it is understood that computing device 14 and evaluation system 30 are only representative of various possible equivalent computing devices that may perform the various process steps of the invention. To this extent, in other embodiments, computing device 14 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively.

Similarly, computer infrastructure 12 is only illustrative of various types of computer infrastructures for implementing the invention. For example, in one embodiment, computer infrastructure 12 comprises two or more computing devices (e.g., a server cluster) that communicate over any type of wired and/or wireless communications link, such as a network, a shared memory, or the like, to perform the various process steps of the invention. When the communications link comprises a network, the network can comprise any combination of one or more types of networks (e.g., the Internet, a wide area network, a local area network, a virtual private network, etc.). Regardless, communications between the computing devices may utilize any combination of various types of transmission techniques.

As previously mentioned and discussed further herein, evaluation system 30 enables computing infrastructure 12 to evaluate a project manager 16A. To this extent, evaluation system 30 is shown including a project module 32 for obtaining information on a project, a survey module 34 for providing a survey 50 for access by one or more project participants 16C, a feedback module 36 for obtaining at least one completed survey 50, and an evaluation module 38 for compiling the completed survey(s) 50 into a score for project manager 16A. Additionally, evaluation system 30 is shown including a request module 40 for receiving a request for a report 52 that is based on the completed survey(s) 50 and a presentation module 42 for providing access to a web page for report 52 to a recipient 18. Operation of each of these systems is discussed further below. However, it is understood that some of the various systems shown in FIG. 1 can be implemented independently, combined, and/or stored in memory for one or more separate computing devices that are included in computer infrastructure 12. Further, it is understood that some of the systems and/or functionality may not be implemented, or additional systems and/or functionality may be included as part of environment 10.

In one embodiment, the invention comprises a web-based tool for providing feedback regarding the performance of project manager 16A during a project. In this case, computer infrastructure 12 can comprise a web server that manages surveys 50, which are periodically provided to participants 16C in the project for completion. Each survey 50 can be electronically mailed and/or participants 16C can access a web page that is generated by computer infrastructure 12. In any event, computer infrastructure 12 can generate a report 52 based on the completed survey(s) 50, and project manager 16A can be provided report 52 via a web page and/or electronic mail generated by computer infrastructure 12.

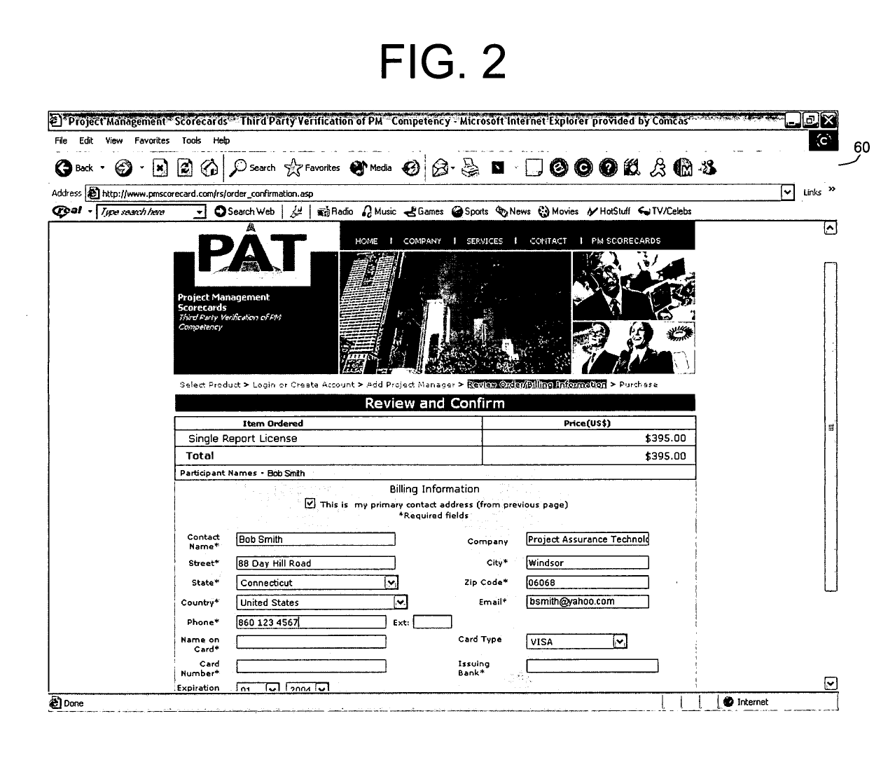

Initially, a customer can use licensing system 44 to purchase a license to use evaluation system 30. Licensing system 44 can enable various types of licenses. For example, the customer could be a project manager 16A that is seeking to use evaluation system 30 for a single project. Alternatively, the customer could comprise an upper-level manager that is seeking to evaluate several project managers 16A that he/she supervises. To this extent, licensing system 44 can enable the customer to specify a single use license (i.e., one project), a multi-use license (i.e., a set number of projects), a time-limited license (e.g., any number of projects for one year), and/or the like. In one embodiment, licensing system 44 generates licenses on a per-project basis. To this extent, as described further herein, multiple evaluations could be conducted for a single project (e.g., periodically during the project). Alternatively, licensing system 44 can generate licenses on a per-evaluation basis. Regardless, licensing system 44 can obtain various billing/payment information and the like in conjunction with the purchased license. For example, FIG. 2 shows an illustrative screen 60 that summarizes the purchase of a single use license and obtains the payment information.

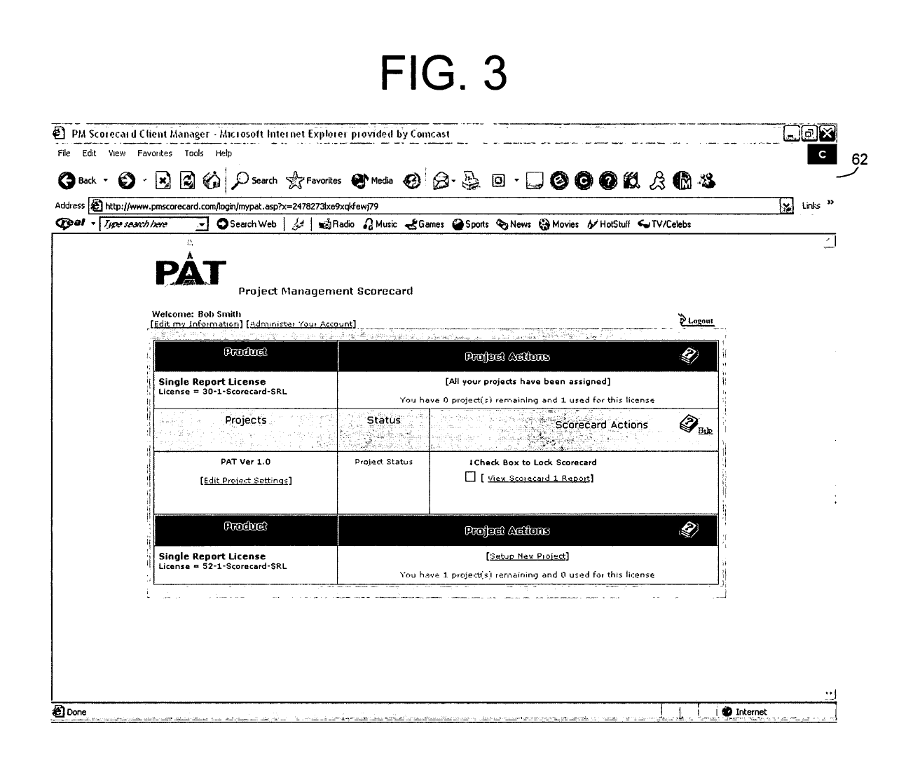

Additionally, licensing system 44 can generate a unique identification for the customer. For example, licensing system 44 can generate a user name/password pair as is known in the art. In this case, the customer can request various information on the license(s) he/she has purchased. In response, licensing system 44 could generate a screen that includes various details about the license(s), e.g., how many projects have been evaluated, how many are available, etc. For example, FIG. 3 shows an illustrative screen 62 that summarizes the status of two single report (use) licenses for a customer.

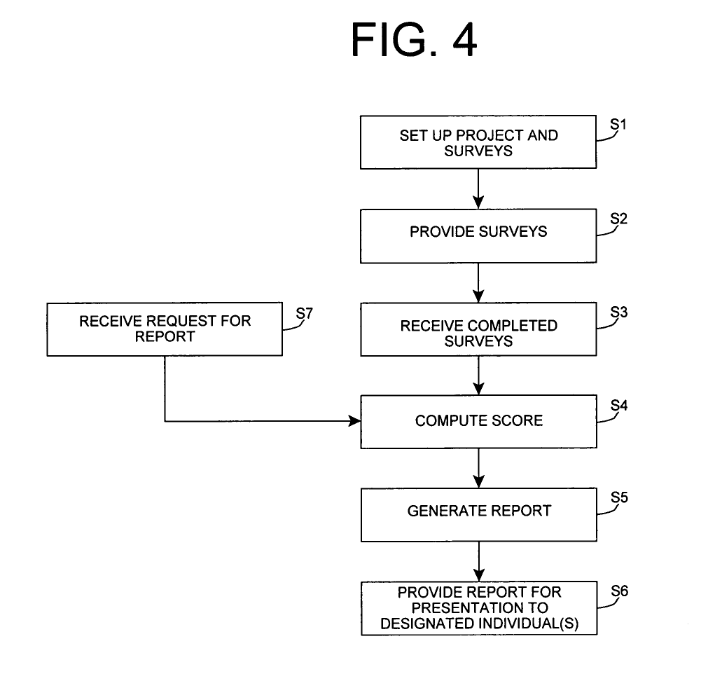

Once use of evaluation system 30 for a project has been licensed, the performance of project manager 16A for the project can be evaluated using evaluation system 30. To this extent, FIG. 4 shows illustrative method steps that can be performed by evaluation system 30 according to one embodiment of the invention. Referring to both FIGS. 1 and 4, in step S1, project module 32 can set up the project and corresponding surveys. In particular, project module 32 can obtain information about the project. To this extent, for each project, project module 32 can obtain a project contact 16B. Project contact 16B comprises an individual that will oversee the evaluation process for the particular project. To this extent, project contact 16B could be project manager 16A, a supervisor of project manager 16A, or the like. Optionally, the identification of the customer could be used as project contact 16B. Alternatively, the customer can designate project contact 16B. In any event, project module 32 can obtain an identification (e.g., user name/password) for project contact 16B.

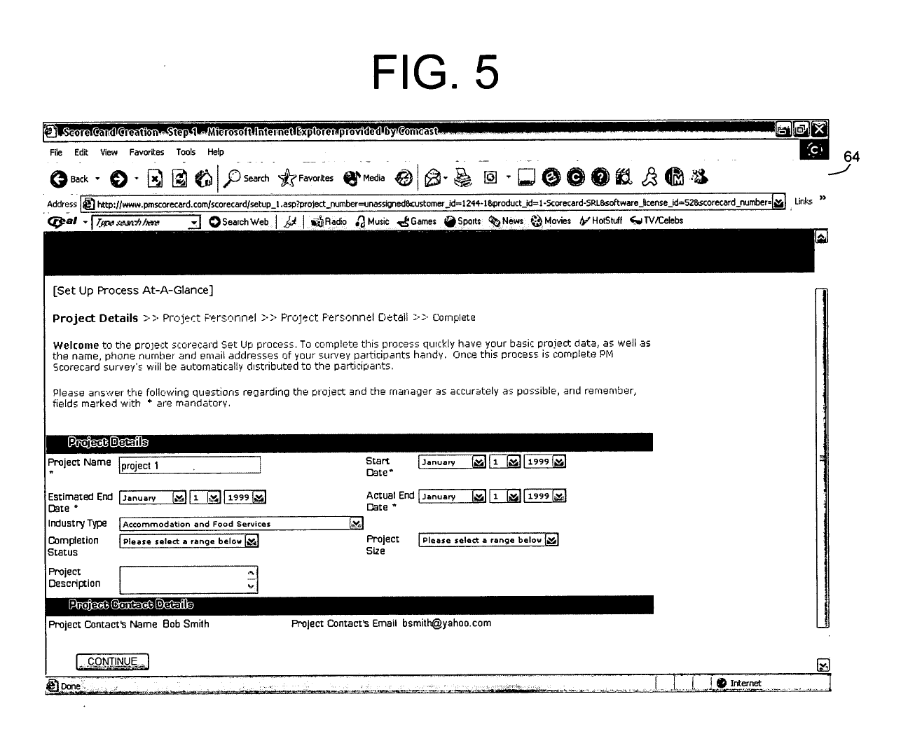

After providing the correct identification, project contact 16B can use project module 32 to provide information about the project. For example, FIG. 5 shows an illustrative screen 64 that can be generated by project module 32 to enable project contact 16B to specify various project details (e.g., name, start/end dates, status, size, etc.). Returning to FIGS. 1 and 4, project module 32 can generate additional screens that enable project contact 16B to specify additional information. For example, project module 32 can generate a screen that obtains the project manager 16A for the project. Additionally, project module 32 can generate a screen that obtains a set of participants 16C in the project. To this extent, project module 32 can obtain participant information for project manager 16A and/or each participant 16C. The participant information can comprise, for example, a participant name, an electronic mail address, a facsimile number, a telephone number, a mailing address, and/or the like.

Additionally, project contact 16B can use project module 32 to set up one or more surveys 50. In one embodiment, each survey 50 can seek to determine the extent to which participants 16C have a shared view of the priorities of various topics/aspects of the project. Further, each survey 50 can seek to determine the quality of communication between project manager 16A and each participant 16C. To this extent, project contact 16B can specify various questions to be asked in survey 50 on various topics related to the project. In general, the topics can include different project-related concerns, such as its business performance, project performance and team performance. In each topic, survey 50 can include one or more questions regarding the priorities and/or performance of project manager 16A for a particular aspect of the topic for the project.

In one embodiment, the content of survey 50 is altered based on a role of each participant 16C. The role for each participant 16C can be provided as participant information by project contact 16B using project module 32 as discussed above. In general, roles in a project include the project manager, a sponsor, a stakeholder, a team member, and a customer. An individual in each particular role has a unique perspective on the project. To this extent, survey 50 can be altered so that the questions included therein are relevant to the perspective of the participant 16C. In particular, project module 32 can rephrase a particular question based on the perspective of participant 16C, ask different questions in a particular topic based on the perspective, and/or the like. Additionally, the content of surveys 52 can be altered based on other aspects of the project, such as a project type, an industry, an organizational structure, and/or the like.

After the project and/or surveys have been initiated, one or more surveys 50 can be used to evaluate the effectiveness of project manager 16A. To this extent, in step S2 of FIG. 4, survey module 34 can provide one or more surveys 50 for access by each participant 16C. For example, survey module 34 can send a survey 50 to each participant 16C via electronic mail, either as an attachment and/or as the content of the electronic message itself. Further, survey module 34 can send survey 50 via a facsimile and/or a mail/courier service. Still further, survey module 34 can send an electronic mail that includes a link that each participant 16C can use to access survey 50 via a network, such as the Internet. In this case, the identity of a participant 16C can be confirmed prior to allowing completion of the survey to ensure that an individual does not complete multiple surveys and that the correct individual is completing the survey. In one embodiment, each participant 16C can have a unique identifier, such as a user name/password. Additionally, the link for the survey 50 can be unique for each participant 16C.

Survey module 34 can select one of a plurality of surveys 50 for presentation based on the participant 16C. For example, as discussed above, survey 50 can be altered based on a role of the participant 16C. To this extent, once participant 16C is identified, his/her corresponding role can be identified and the correct survey 50 can be provided. In any event, survey 50 includes a set of questions regarding the priority of each of a set of aspects of the project. Each participant 16C is asked to indicate the priority of each aspect based on his/her understanding of the project. Using the completed surveys 50, an effectiveness with which project manager 16A understood and conveyed the priorities of the project to various participants 16C can be evaluated. Such communication is one critical element in the performance of a project manager 16A. As a result, completed surveys 50 can accurately and quantitatively assess the performance of project manager 16A.

As noted previously, survey 50 can include questions on various topics for the project. Further, the questions can address the relative priorities of each topic and/or certain aspects of each topic. For example, survey 50 can request that participant 16C rank the relative importance of topics, such as business performance, project performance, and project team performance. Subsequently, survey 50 can request that participant 16C rank the relative importance of various aspects (e.g., measurement areas) of each topic. For example, survey 50 can request that participant 16C rank: the importance of market impact, organizational impact, and strategic impact for business performance; the importance of cost, schedule, and quality (performance) for project performance; and the importance of communication, resource management, and team dynamics for project team performance. Subsequently, within each topic/aspect, one or more survey questions can also be included for participant 16C to answer.

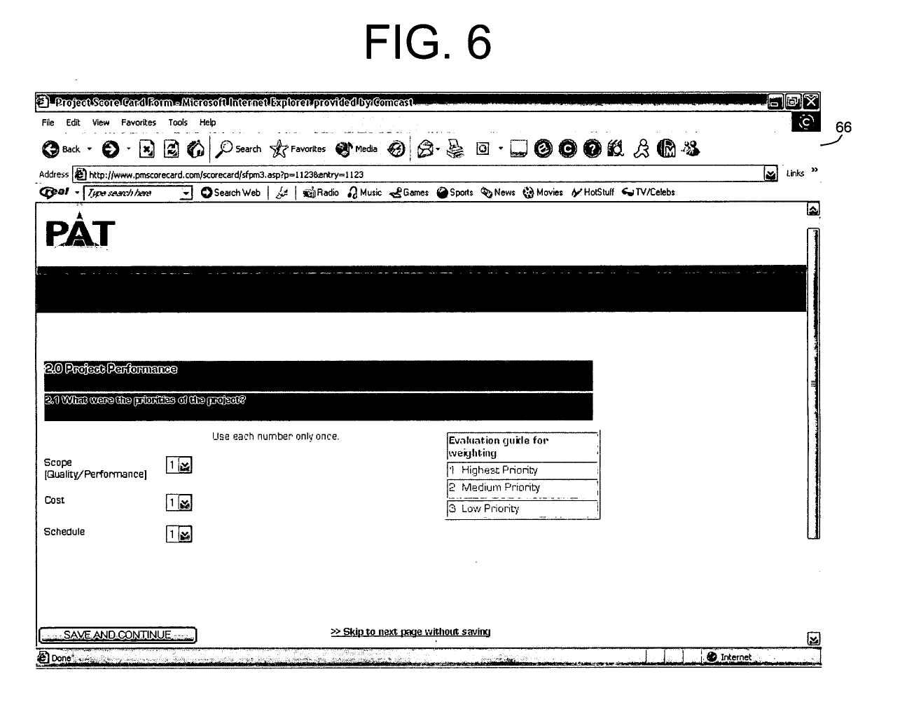

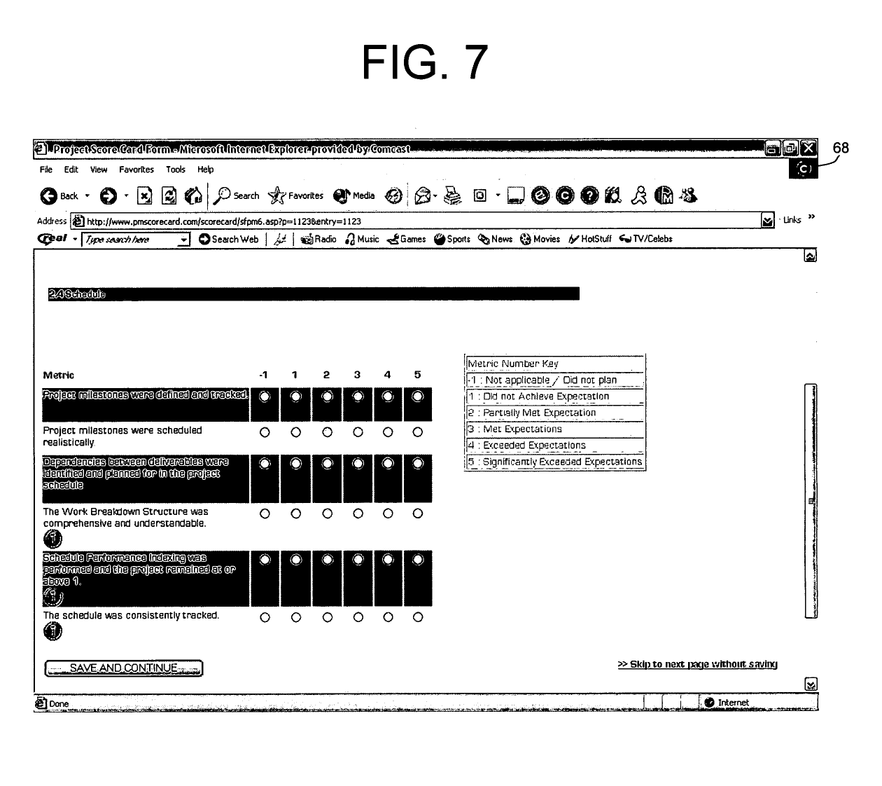

In one embodiment, survey module 34 generates a series of screens for display to participant 16C in completing survey 50. Each screen can include one or more questions that are to be completed by participant 16C. To this extent, FIG. 6 shows an illustrative screen 66 that survey module 34 can generate for display to participant 16C as part of survey 50. In particular, screen 66 requests that participant 16C rank the relative importance of scope (e.g., quality/performance), cost and schedule within the project performance topic. Similarly, FIG. 7 shows an illustrative screen 68 that requests that participant 16C rank the performance of project manager 16A on communicating a schedule for the project based on a numeric grading scale.

As discussed above, the wording and/or selection of questions can be adjusted based on a role of participant 16C. For example, a participant 16C that comprises a customer frequently will be asked a different question than a participant 16C that comprises a team member. To this extent, with respect to the cost of a project, a customer participant 16C can be asked a question regarding how well project manager 16A performed in delivering value commensurate with the cost incurred by the customer. However, the team member participant 16C can be asked a question regarding the amount of resources that were allocated by project manager 16A, and whether these were sufficient to perform his/her project work.

Returning to FIGS. 1 and 4, in step S3, feedback module 36 obtains the completed survey(s) 50 from one or more of the participants 16C. For example, feedback module 36 may receive an electronic mail containing a completed survey 50, data entered using screens 66, 68 (FIGS. 6 and 7) could be provided by survey module 34 after survey 50 has been completed, a completed survey 50 could be faxed/mailed to feedback module 36, or the like. In any event, feedback module 36 can compile all completed survey(s) 50 for a particular project. Feedback module 36 can manage a time frame within which survey 50 should be completed by all participants 16C. To this extent, when one or more participants 16C have not completed survey 50 after a preset time period, feedback module 36 can provide a reminder for the participant(s) 16C requesting that survey 50 be completed. For example, the reminder can comprise an electronic mail, a facsimile, a telephone message, or the like. In any event, feedback module 36 can store the data for the completed survey(s) 50 in any manner, such as a database or the like, as is known in the art.

In step S4, evaluation module 38 can compile the completed survey(s) 50 for the project into a score for project manager 16A. In particular, evaluation module 38 can generate the score after a time period for survey 50 has expired, after all participants 16C have responded, after receiving a notification from feedback module 36, or the like. In any event, the score comprises a metric with which the performance of project manager 16A on an individual project can be objectively quantified. The score can comprise a value within any range of values, such as between zero and one hundred. In one embodiment, evaluation module 38 compiles the score using a weighted average for the questions, roles, and/or individuals. Further, evaluation module 38 can calculate a standard deviation for the completed surveys 50 using the assigned weights. Subsequently, the score can be calculated based on an accuracy of the answers and the standard deviation. For example, a lower standard deviation is an indication that many answers were similar, which in turn is an indication that project manager 16A successfully conveyed the particular priority to the individual(s).

Project contact 16B can use project module 32 to assign a weight to each question in the survey 50 and/or role for participants 16C in step S1. In one embodiment, the weights are assigned based on a relative importance (e.g., priority) of the subject matter of the question. To this extent, the general ranking of the topics and/or aspects described above can be given a relatively high overall weight, with the individual questions under each aspect being given a lower overall weight. Further, the weight(s) can be assigned/adjusted automatically by evaluation module 38. For example, a participant 16C whose answers are substantially different from all other participants 16C could be given less weight.

Using the assigned weights, evaluation module 38 can average the responses to each question and average the survey responses in a known manner to obtain a weighted average for the survey 50, which can be used as the score for project manager 16A. For example, the score can be calculated using a “double” weighted average. To this extent, each topic (e.g., business performance, project performance, and project team performance) can be assigned a weight relative to one another. Further, each topic can include a plurality of aspects (e.g., schedule, cost, quality for the project performance topic) each of which is also assigned a weight relative to the other aspects for the topic. Subsequently, a score for each aspect can be determined by averaging the scores for all questions in that aspect to obtain an aspect score, the aspect scores for a topic can be averaged using the assigned weights to obtain a topic score, and the topic scores can be averaged using the assigned weights to obtain the overall score. Additionally, evaluation module 38 can calculate a standard deviation for the responses using the weights. Subsequently, the standard deviation and the weighted average can be combined to obtain the score for project manager 16A. Alternatively, the standard deviation can be used to supplement the score for project manager 16A. In any event, the overall score can then be scaled as desired based on its relation to a minimum and maximum possible score.

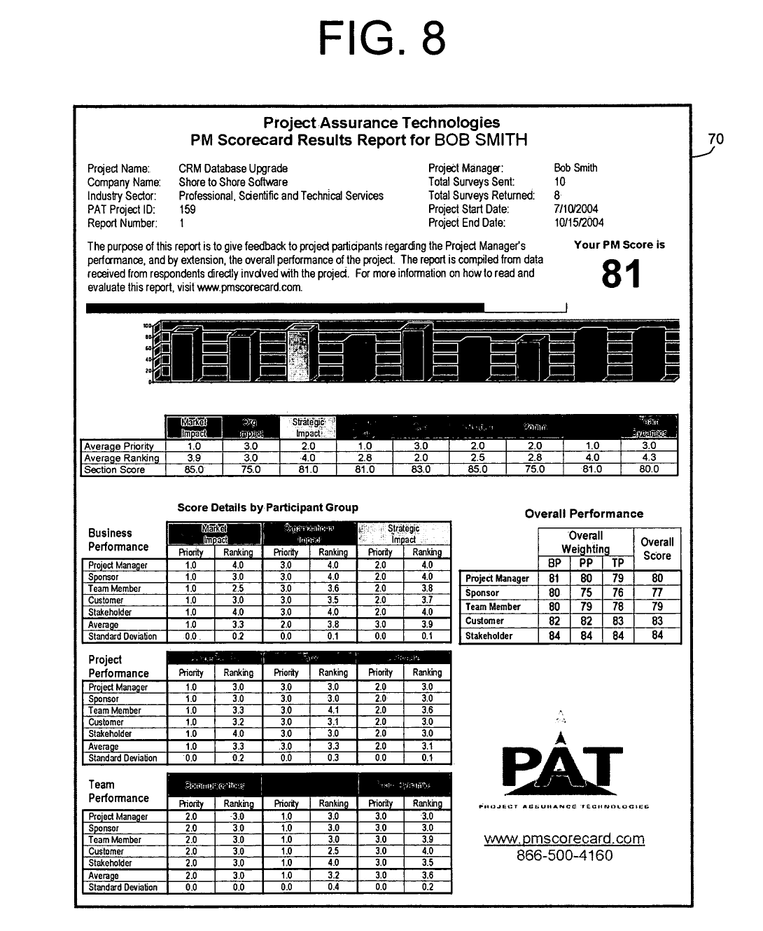

Further, in step S5, evaluation module 38 can generate a report 52 based on the completed survey(s) 50. Report 52 can include various information on the project, project manager 16A, and the like. Further, report 52 can include the compiled score as well as information on how the score was computed. Report 52 can be generated in any desired format and fixed in any tangible form of expression. For example, report 52 could comprise an electronic file, such as an HTML document, an image file, a portable document format (PDF), a physical document, or the like. To this extent, FIG. 8 shows an illustrative report 70 according to one embodiment of the invention. As shown, report 70 includes various information on the particular project, the numeric score and a graphical indication of the score, as well as various charts that break down the computation both by topic/aspect and by role. In this case, when reviewing report 70, an individual can readily determine a level of involvement in the project for each particular role (e.g., participant group). In one embodiment, data corresponding to each topic/aspect is color-coded to enable an individual to quickly scan and locate desired contents. Additionally, report 70 can be configured so that it can be printed on a single sheet of paper for quick reference and easy storage.

Returning to FIGS. 1 and 4, in step S6, presentation module 42 can provide report 52 for presentation to one or more designated individual(s), i.e., recipient(s) 18. In setting up the project, project contact 16B can specify one or more recipients 18 as part of the project information provided using project module 32. To this extent, a set of default recipients 18, such as project manager 16A and/or project contact 16B, can always be designated to receive report 52. Regardless, presentation module 42 can provide report 52 to each recipient 18 in any known manner. For example, presentation module 42 can send an electronic message that includes a link to a web page for report 52 to each recipient 18. Alternatively, a user can seek to access a link for the report 52 or request an electronic message that includes report 52, e.g., by specifying the project in a user interface generated by presentation module 42. In either case, prior to displaying the web page, presentation module 42 can confirm that an authorized recipient 18 has requested access to report 52 by first identifying the individual (e.g., user name/password). When recipient 18 is permitted to access report 52, presentation module 42 can provide the web page for report 52 for display to recipient 18, send a copy of report 52 to recipient 18, or the like.

Further, evaluation module 38 and/or presentation module 42 can generate and/or provide report 52 “on demand”, e.g., in response to a request. To this extent, in step S7, request module 40 can receive a request for report 52. For example, the request can comprise an electronic message, a facsimile, a telephone call, or the like. In any event, the request can identify one or more recipients 18 to receive report 52. Upon receiving the request, request module 40 can confirm that an authorized individual (e.g., project manager 16A or project contact 16B) has requested report 52. The authorized individual can request that report 52 be generated for viewing by the individual him/herself and/or one or more third party recipients 18. When a third party recipient 18 is included, contact information, such as an electronic mail address, a facsimile number, a mailing address, or the like, can be included in the request. When the request is received from an authorized individual, evaluation module 38 can generate report 52 and/or presentation module 42 can provide report 52 to the designated recipient(s) 18 as discussed above.

As a result, evaluation system 30 provides an improved solution for evaluating the performance of a project manager 16A in a project-by-project basis. In one embodiment, multiple surveys 50 are conducted for a single project. In this manner, project manager 16A can receive feedback while the project is progressing, thereby enabling project manager 16A to make any necessary modifications to improve his/her management of the project.

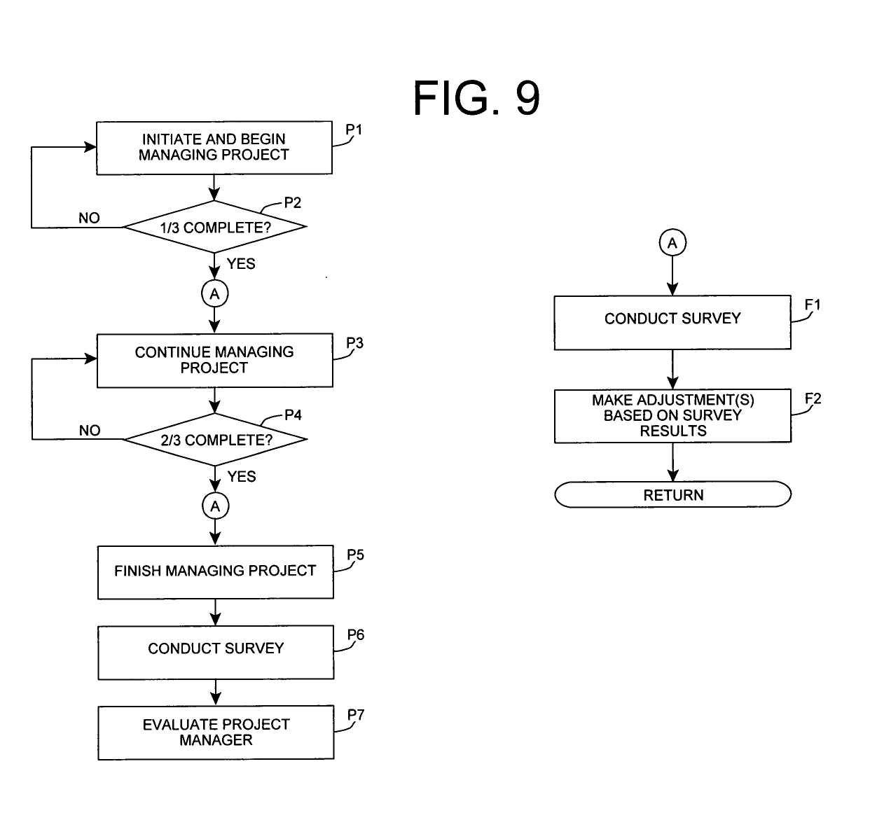

To this extent, FIG. 9 shows illustrative method steps for periodically evaluating project manager 16A according to one embodiment of the invention. In particular, referring to FIGS. 1 and 9, in step P1, project manager 16A can initiate and begin managing the project. In step P2, project manager 16A can determine when the project is approximately one-third complete. For example, in a typical project, this could comprise the completion of a certain set of tasks. In any event, once the project has progressed to this point, flow proceeds to step F1, in which the survey 50 is conducted as discussed above. In step F2, project manager 16A can review the results of survey 50 and make any necessary adjustments to his/her management of the project. In any event, in step P3, project manager 16A continues managing the project. In step P4, project manager 16A can determine if the project is approximately two-thirds complete. If so, then a second survey 50 is conducted in step F1 and any necessary adjustments are made in step F2. Subsequently, in step P5, project manager 16A can substantially finish managing the project. When the project is complete or near completion, in step P6, a third survey 50 can be conducted. In step P7, project manager 16A can be evaluated in light of the three surveys 50 and the results of the project. For example, the results of each survey 50 can be aggregated to generate an overall score for project manager 16A. In this case, the first survey 50 can be weighted to account for less of the overall score, while the last survey 50 can be weighted to account for more of the overall score.

In one embodiment, evaluation system 30 is managed by a third-party, who provides evaluations for numerous project managers 16A on numerous projects. To this extent, it is important that the evaluations remain credible. In order to ensure that evaluation system 30 (FIG. 1) is being used effectively and provides meaningful evaluations, project evaluations can be randomly and periodically audited using an audit system (not shown) or the like, included in evaluation system 30. For example, a defined percentage of projects (e.g., ten percent) can be randomly selected for auditing. The audits can have various levels. For example, a first level audit could review the contact information (e.g., emails) for a group of participants 16C to determine if suspicious contact information is included (e.g., they all are for a free email service). In a second level audit, a follow up for a project can be conducted to ensure that the project was a real project, that the participants 16C were real individuals, that they completed the surveys 50, and the like. In this audit, a minimum number of participants 16C (e.g., five) can be contacted to confirm the validity of the project. In a third level audit, a full investigation of the project can be conducted, which includes, for example, contacting all participants 16C to verify participation and examining and/or verifying the project. The project can be verified by, for example, collecting a project document from the project, conducting interviews, or the like. The third level audit can be triggered, for example, by suspicious activity noticed in a first or second level audit. When a project fails the audit, the evaluation can be flagged as invalid and/or the project manager 16A can be prevented from continuing to use the system.

While shown and described herein as a method and system for evaluating a project manager, it is understood that the invention further provides various alternative embodiments. For example, in one embodiment, the invention provides a computer-readable medium that includes computer program code to enable a computer infrastructure to evaluate a project manager. To this extent, the computer-readable medium includes program code, such as evaluation system 30 (FIG. 1), that implements each of the various process steps of the invention. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computing device, such as memory 22A (FIG. 1) and/or storage system 22B (FIG. 1) (e.g., a fixed disk, a read-only memory, a random access memory, a cache memory, etc.), and/or as a data signal traveling over a network (e.g., during a wired/wireless electronic distribution of the program code).

In another embodiment, the invention provides a business method that performs the process steps of the invention on a subscription, advertising, and/or fee basis. That is, a service provider, such as an Application Service Provider, could offer to evaluate a project manager as described above. In this case, the service provider can manage (e.g., create, maintain, support, etc.) a computer infrastructure, such as computer infrastructure 12 (FIG. 1), that performs the process steps of the invention for one or more customers. In return, the service provider can receive payment from the customer(s) under a subscription and/or fee agreement and/or the service provider can receive payment from the sale of advertising space to one or more third parties.

Further, the invention provides a business method for providing a third-party evaluation of project manager 16A. In particular, a service provider can manage a set (one or more) of reports 52 (FIG. 1) that evaluate the performance(s) of one or more project managers 16A (FIG. 1). Subsequently, a project manager 16A may seek new employment, seek a new project, or the like. In this case, project manager 16A, or another authorized user, can request that the service provider provide one or more reports 52 to a prospective hiring party. In return for payment from the authorized user, the service provider can send the report(s) 52 directly to the prospective hiring party. Further, the service provider can authenticate the source of the report(s) 52 using a watermark, seal, or the like. In this manner, reports 52 can be used to supplement a resume, interview, and/or school transcript. Additionally, the service provider can provide a one page summary that summarizes the results of all of the reports 52 and/or makes any observations of strong/weak points of the project manager 16A.

Still further, the invention provides a business method for providing a project manager 16A (FIG. 1) certification program. In particular, a service provider, such as an educational institution, can evaluate the performance of project manager 16A over the course of a series of projects in return for payment. The projects can be planned and conducted as part of the certification program and/or be conducted as part of the project manager 16A's employment. In any event, the service provider can set a series of performance standards for project manager 16A. When these standards are met, the service provider can certify that the project manager 16A has met its standards. Further, the service provider can require that the project manager 16A periodically prove that he/she continues to meet the performance standards in order to maintain the certification. In this case, the certification can be used to distinguish the project manager 16A from others, as well as provide a third party with assurance that the project manager 16A typically meets certain performance criteria.

In still another embodiment, the invention provides a method of generating a system for evaluating a project manager. In this case, a computer infrastructure, such as computer infrastructure 12 (FIG. 1), can be obtained (e.g., created, maintained, having made available to, etc.) and one or more systems for performing the process steps of the invention can be obtained (e.g., created, purchased, used, modified, etc.) and deployed to the computer infrastructure. To this extent, the deployment of each system can comprise one or more of (1) installing program code on a computing device, such as computing device 14 (FIG. 1), from a computer-readable medium; (2) adding one or more computing devices to the computer infrastructure; and (3) incorporating and/or modifying one or more existing systems of the computer infrastructure, to enable the computer infrastructure to perform the process steps of the invention.

As used herein, it is understood that the terms “program code” and “computer program code” are synonymous and mean any expression, in any language, code or notation, of a set of instructions intended to cause a computing device having an information processing capability to perform a particular function either directly or after any combination of the following: (a) conversion to another language, code or notation; (b) reproduction in a different material form; and/or (c) decompression. To this extent, program code can be embodied as one or more types of program products, such as an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A method of evaluating a project manager, the method comprising:
obtaining a set of participants in a project managed by the project manager;
providing a survey for access by each of the set of participants, wherein the survey is altered based on a role of each participant;
obtaining a completed survey from at least one of the set of participants; and
compiling the at least one completed survey into a score for the project manager.

2. The method of claim 1, further comprising generating a report based on the at least one completed survey.

3. The method of claim 2, further comprising sending an electronic message that includes a link to a web page for the report to at least one recipient.

4. The method of claim 2, further comprising:
receiving a request from a user to access a link to a web page for the report;
verifying a permission of the user to access the link; and
providing the web page for display to the user when access is permitted.

5. The method of claim 2, further comprising receiving a request for the report, wherein the generating step is performed in response to the request.

6. The method of claim 5, wherein the request identifies at least one third party recipient for the report.

7. The method of claim 1, wherein the providing and obtaining a completed survey steps are performed periodically during the project.

8. The method of claim 1, wherein the survey includes a set of questions regarding the priority of each of a set of aspects of the project.

9. The method of claim 1, further comprising:
obtaining a project contact for the project; and
obtaining information about the project from the project contact.

10. The method of claim 1, wherein the role is selected from the group consisting of a project manager, a sponsor, a stakeholder, a team member, and a customer.

11. The method of claim 1, wherein the compiling step includes:
assigning a weight to each question in the survey; and
averaging the responses to each question using the weights.

12. The method of claim 11, wherein the compiling step further includes:
assigning a weight to each role;
averaging the survey responses using the weights; and
calculating a standard deviation using the weights.

13. A method of generating a system for evaluating a project manager, the method comprising:
obtaining a computer infrastructure; and
for each of the steps of claim 1, deploying a means for performing the step to the computer infrastructure.

14. A computer-readable medium for enabling a computer infrastructure to evaluate a project manager, the computer-readable medium comprising computer program code for performing the method steps of claim 1.

15. A system for evaluating a project manager, the system comprising:
a project module for obtaining a set of participants in a project managed by the project manager;
a survey module for providing a survey for access by each of the set of participants, wherein the survey is altered based on a role of each participant;
a feedback module for obtaining a completed survey from at least one of the set of participants; and
an evaluation module for compiling the at least one completed survey into a score for the project manager.

16. The system of claim 15, wherein the evaluation module further generates a report based on the at least one completed survey.

17. The system of claim 16, further comprising a request module for receiving a request for the report, wherein the evaluation module generates the report in response to the request.

18. The system of claim 16, further comprising a presentation module for providing access to a web page for the report to a recipient.

19. The system of claim 15, wherein the project module further obtains a project contact for the project and obtains information about the project from the project contact.

20. A computer-readable medium for enabling a computer infrastructure to evaluate a project manager, the computer-readable medium comprising computer program code for:
obtaining a set of participants in a project managed by the project manager;
providing a survey for access by each of the set of participants, wherein the survey is altered based on a role of each participant;
obtaining a completed survey from at least one of the set of participants;
compiling the at least one completed survey into a score for the project manager;
generating a report based on the at least one completed survey and the score; and
providing a web page for the report for display to a user.
